(19) United States
(12) Patent Application Publication
(10) Pub. No.: US 2026/0244868 A1
(43) Pub. Date: Aug. 20, 2026

(54) SYSTEMS AND METHODS FOR EXPLAINING THE RELEVANCE OF ANSWERS GENERATED BY A QUESTION-AND-ANSWER MODEL

(71) Applicant: Verizon Patent and Licensing Inc., Basking Ridge, NJ (US)

(72) Inventors: Deepak UPMAN, Bangalore (IN); Subham BISWAS, Thane (IN); Kushal SINGLA, Bangalore (IN)

(73) Assignee: Verizon Patent and Licensing Inc., Basking Ridge, NJ (US)

(21) Appl. No.: 19/058,311

(22) Filed: Feb. 20, 2025

(51) Int. Cl. G06F 40/30; G06F 16/383

(52) U.S. Cl. CPC G06F 40/30; G06F 16/383

(57) ABSTRACT

A device may receive a query and an answer generated by a model in response to the query, and may determine relevance scores for context documents with respect to the query. The device may rank the context documents with respect to the query based on the relevance scores, and may determine semantic similarity scores for sentences in the context documents with respect to the answer. The device may re-rank the context documents based on the semantic similarity scores and to generate ranked context documents, and may combine the relevance scores and the semantic similarity scores to generate an explainability score for the answer. The device may provide an output that includes the explainability score and a portion of the ranked context documents that support the answer.

### BACKGROUND

In the field of artificial intelligence (AI), specifically within the context of generative AI systems, large language models (LLMs) have become a cornerstone for various enterprise applications, powering everything from customer service bots to internal knowledge management tools.

### BRIEF DESCRIPTION OF THE DRAWINGS

FIGS. 1A-1G are diagrams of an example associated with explaining the relevance of answers generated by a question-and-answer model.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for explaining the relevance of answers generated by a question-and-answer model.

### DETAILED DESCRIPTION OF EXAMPLE EMBODIMENTS

The following detailed description of example implementations refers to the accompanying drawings. The same reference numbers in different drawings may identify the same or similar elements.

The integration of artificial intelligence into question-and-answer models has been a significant advancement in providing more intuitive and responsive services to users. Enterprises have developed complex models that utilize advanced language models to generate nuanced answers based on user queries. Additionally, the performance of these models can be enhanced when the models are coupled with knowledge base retrieval mechanisms. However, while these sophisticated models can provide high-quality responses, it is difficult for operators or users of the models to discern a decision-making process of the models or how the models arrive at conclusions. This difficulty is common in retrieval-augmented generation (RAG) models and large language models (LLMs), and inhibits the ability to validate and improve the model's outputs. Thus, current techniques for analyzing a question-and-answer model consume computing resources (e.g., processing resources, memory resources, communication resources, and/or the like), networking resources, and/or other resources associated with failing to ensure that the question-and-answer model generates correct responses, failing to provide sufficient levels of explainability for responses of the question-and-answer model, generating incorrect responses by the question-and-answer model, making incorrect decisions within an enterprise based on the LLM responses, and/or the like.

Some implementations described herein provide an explainability system that explains the relevance of answers generated by a question-and-answer model. For example, the explainability system may receive a query and an answer generated by a model in response to the query, and may determine relevance scores for context documents with respect to the query. The explainability system may rank the context documents with respect to the query based on the relevance scores, and may determine semantic similarity scores for sentences in the context documents with respect to the answer. The explainability system may re-rank the context documents based on the semantic similarity scores and to generate ranked context documents, and may combine the relevance scores and the semantic similarity scores to generate an explainability score for the answer. The explainability system may provide an output that includes the explainability score and a portion of the ranked context documents that support the answer.

In this way, the explainability system explains the relevance of answers generated by a question-and-answer model. For example, the explainability system may enhance a technical explainability of question-and-answer models. The explainability system may target limitations of the question-and-answer models, and may address the computational efficiency and decision-making process utilized by the question-and-answer models. By integrating relevance and semantic similarity evaluations, the explainability system provides a more detailed analysis of the answer derivation process, pinpointing precisely which sections of context documents are most pertinent to both a query and its answer. The explainability system may validate and refine model outputs against contextually appropriate reference materials. Thus, the explainability system may conserve computing resources, networking resources, and/or other resources that would have otherwise been consumed by failing to ensure that the question-and-answer model generates correct responses, failing to provide sufficient levels of explainability for responses of the question-and-answer model, generating incorrect responses by the question-and-answer model, making incorrect decisions within an enterprise based on the LLM responses, and/or the like.

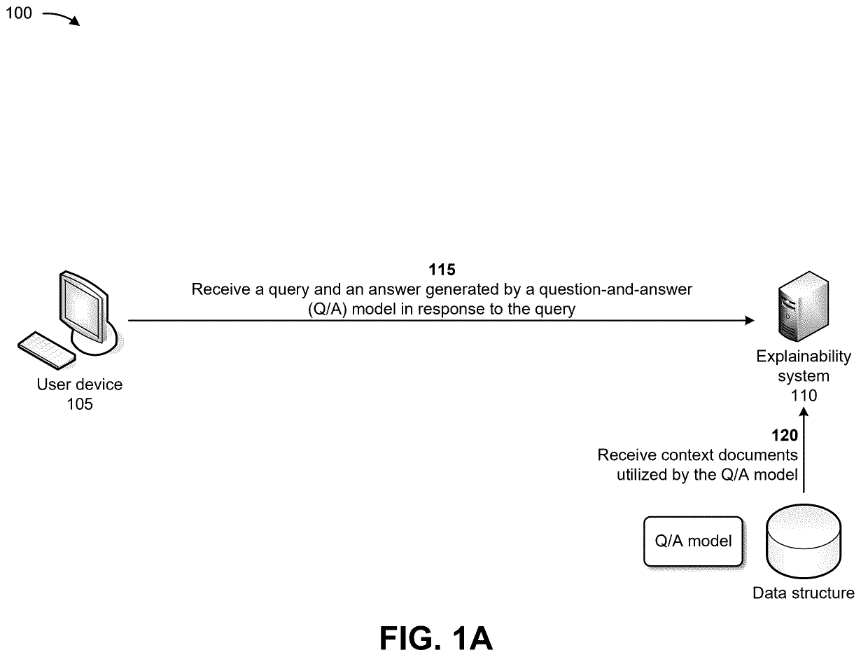

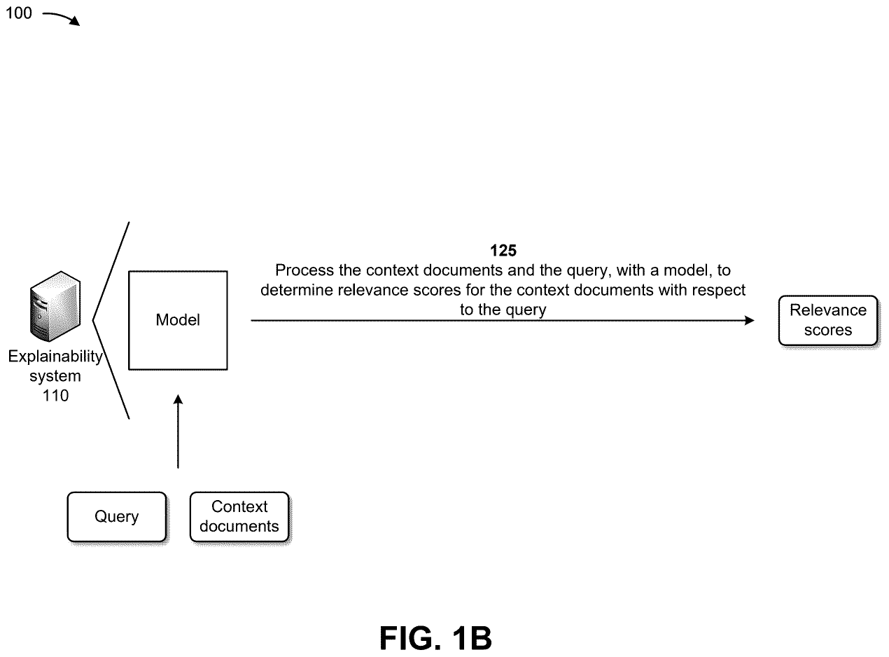

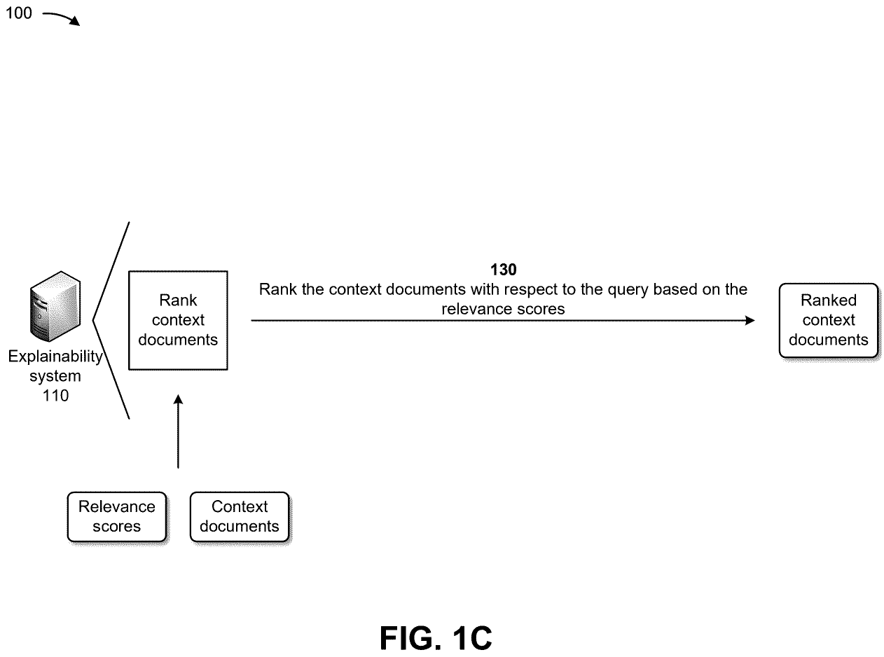

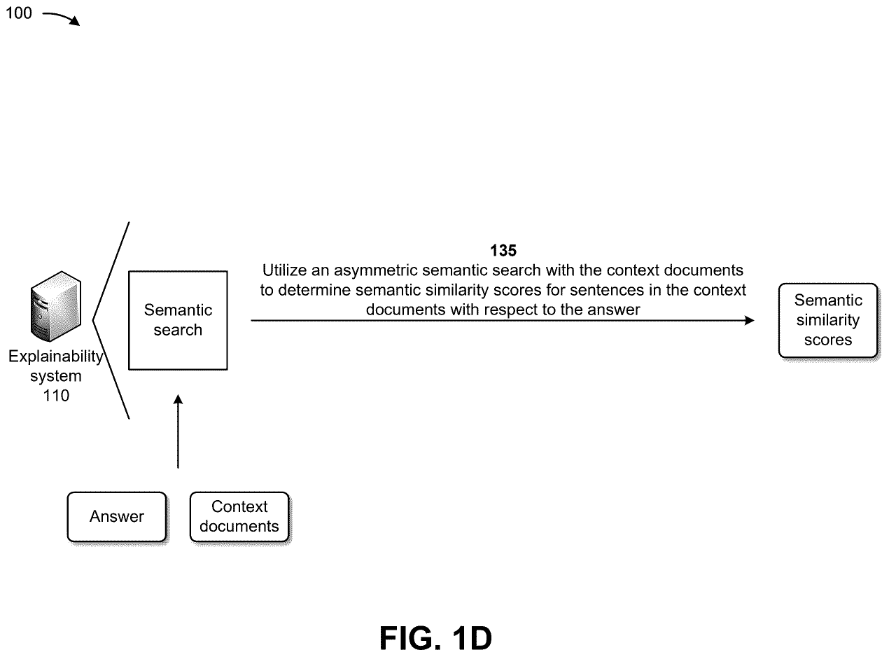

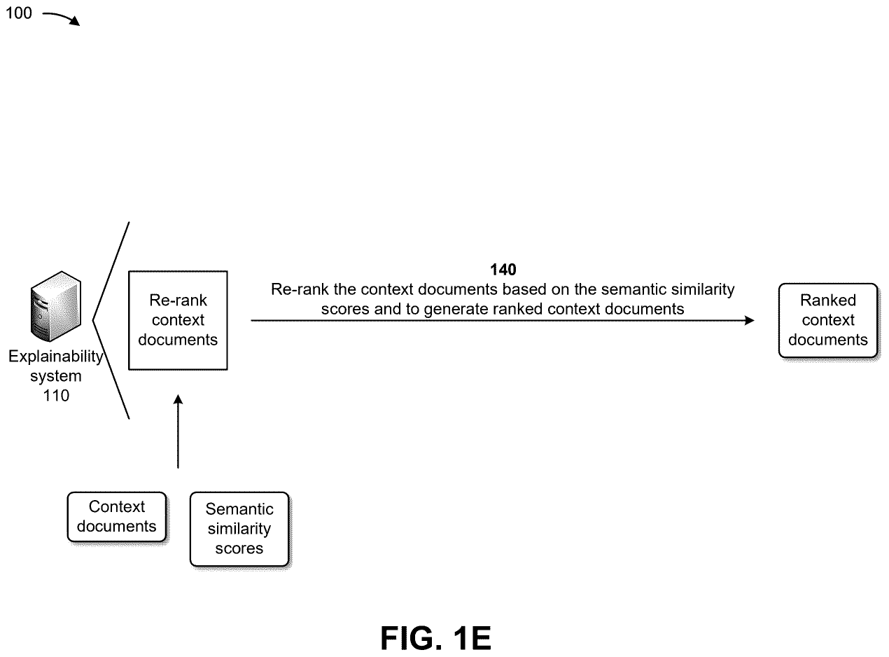

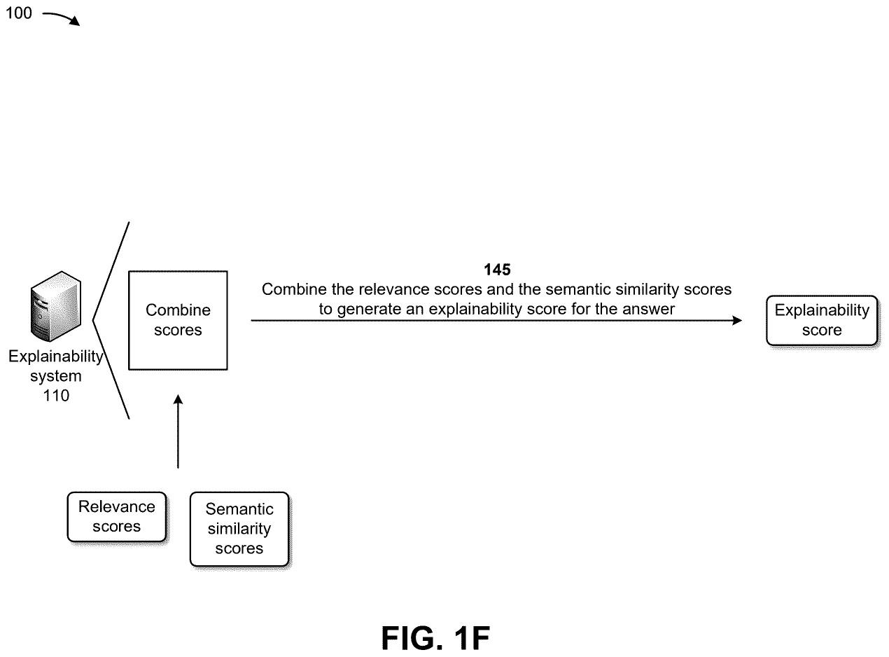

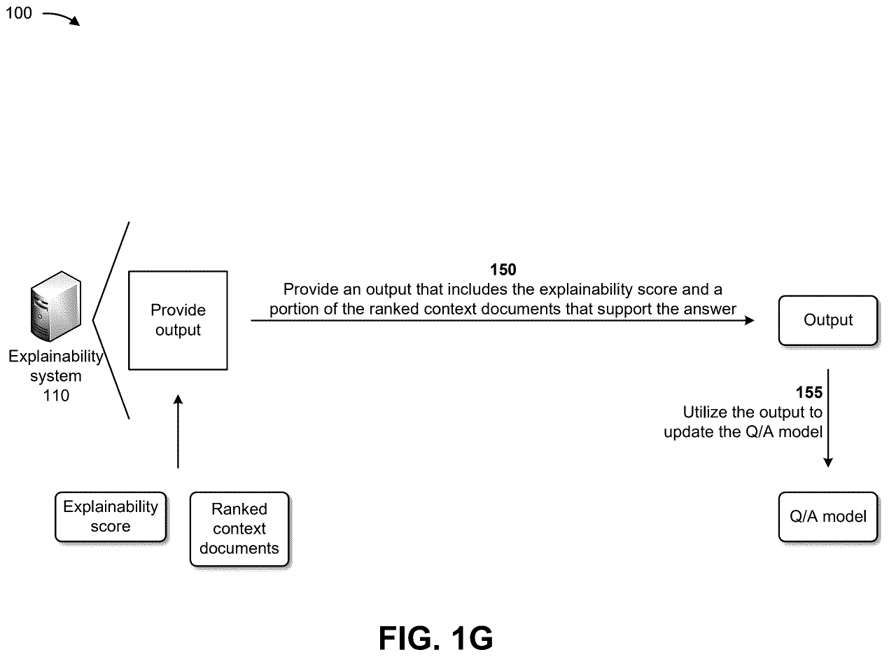

FIGS. 1A-1G are diagrams of an example 100 associated with explaining the relevance of answers generated by a question-and-answer model. As shown in FIGS. 1A-1G, the example 100 includes a user device 105 and a data structure associated with an explainability system 110. The user device 105 may provide, to the explainability system 110, queries provided to a question-and-answer (Q/A) model and answers generated by the question-and-answer model in response to the queries. The data structure may include a database, a table, a list, and/or the like that stores information to be utilized by the question-and-answer model (e.g., a large language model (LLM), a retrieval-augmented generation (RAG) model, and/or the like). The explainability system 110 may include a system that explains the relevance of answers generated by a question-and-answer model. Further details of the user device 105, the data structure, and the explainability system 110 are provided elsewhere herein. Although implementations described herein depict a single user device 105, in some implementations, the explainability system 110 may be associated with multiple user devices 105.

As shown by FIG. 1A, and by reference number 115, the explainability system 110 may receive a query and an answer generated by a Q/A model in response to the query. For example, the user device 105 may provide, to the explainability system 110, a query and an answer generated by a Q/A model in response to the query. The explainability system 110 may receive the query and the answer from the user device 105. In some implementations, the explainability system 110 may receive the query and the answer from a system that provides the question-and-answer model. The system may receive the query from the user device 105, and may process the query, with the question-and-answer model, to generate the answer. The system may provide the answer, for display, to the user device 105, and may provide the query and the answer to the explainability system 110.

In some implementations, the explainability system 110 may perform an initial preprocessing on the query and/or the answer to remove any redundant data before further analysis. The preprocessing may ensure that only relevant and unique data is available for subsequent processing by the explainability system 110. The preprocessing may include removing stopwords, normalizing case, tokenizing input text, and potentially performing lemmatization to reduce the inflectional forms of words to their base forms. Additionally, the context documents may be indexed using a search engine like Elasticsearch, facilitating rapid retrieval by maintaining an inverted index that maps tokens to their occurrences in the document corpus. The explainability system 110 is constructed to integrate these components effectively, relying, for example, on established data structures and distributed processing frameworks like Apache Hadoop or Apache Spark to handle large-scale data.

Additionally, or alternatively, the explainability system 110 may temporarily store the query and the answer in a cache to enhance a processing speed of future queries involving similar contexts by the explainability system 110. Storing the query and the answer in a cache may provide for rapid retrieval by the explainability system 110, minimizing latency in handling recurring queries. Additionally, or alternatively, the user device 105 may also provide, to the explainability system 110, supplementary information about a context of the query, such as the metadata or session details. This supplementary information may provide additional insights that refine the process of relevance determination by the explainability system 110, as described elsewhere herein.

As further shown in FIG. 1A, and by reference number 120, the explainability system 110 may receive context documents utilized by the question-and-answer model. For example, the explainability system may be associated with a data structure that stores the context documents utilized by the question-and-answer model. The context documents may be utilized by the question-and-answer model to generate answers to queries provided to the model. In some implementations, the explainability system 110 may provide a request for the context documents to the data structure, and may receive the context documents from the data structure based on the request. In some implementations, the user device 105 may cause the data structure to provide the context documents to the explainability system 110.

In some implementations, the explainability system 110 may utilize the context documents to determine the relevance and support of the answer to the query based on the context provided by the context documents. In some implementations, the explainability system 110 may index a semantic search engine for faster retrieval of the context documents. The indexing may facilitate more efficient and rapid access to the context documents during analysis processes. Additionally, or alternatively, the context documents may be periodically updated or augmented to ensure that the most current and relevant context documents are being utilized by the question-and-answer model and the explainability system 110. Periodic updates may maintain the relevance and accuracy of the context documents utilized to generate answers by the question-and-answer model. Additionally, or alternatively, along with context documents, the explainability system 110 may utilize external data sources, such as publicly available databases or trusted online resources, to verify the accuracy of generated answers by the question-and-answer model. External data sources may provide an additional layer of verification and may enhance the reliability of the answers generated by the question-and-answer model.

As shown in FIG. 1B, and by reference number 125, the explainability system 110 may determine relevance scores for the context documents with respect to the query. In some implementations, the explainability system 110 may process the context documents and the query, with a model (e.g., a cross-encoder model), to determine the relevance scores. For example, the explainability system 110 may utilize a cross-encoder model that receives a query and context documents and produces relevance scores indicating the relevance of the context documents to the query. The cross-encoder may perform analyze the query and each context document to evaluate the relevance of the context document to the query and to ensure that the relevance scores accurately reflect contextual relationships. The cross-encoder model may utilize a classification model, with data pairs (e.g., where each pair includes the query and a context document), to generate a relevance score that ranges from zero (0) to one (1) and indicates a confidence level of a relevance of a context document to the query (e.g., how closely content of the context document matches the query). The cross-encoder model may comprehensively assess and weigh the significance of different sections of the context documents with respect to the query. In some implementations, the explainability system 110 may process the query and the context documents to generate context vector embeddings, and may utilize the cross-encoder model with the context vector embeddings to determine the relevance scores. For example, the explainability system 110 may embed the context documents and the query into a vector space, and may determine that context documents associated with embeddings that are closest to embeddings associated with the query are more relevant than context documents associated with embeddings that are further from the embeddings associated with the query.

Additionally, or alternatively, the cross-encoder model may be trained on datasets, such as a machine reading comprehension passage retrieval dataset (e.g., the Microsoft machine reading comprehension (MARCO) passage retrieval dataset), which may enhance an ability of the cross-encoder model to accurately score the relevance of the context documents. The training may enable the cross-encoder model to more precisely differentiate between relevant and non-relevant context documents based on prior learned patterns from extensive datasets.

As shown in FIG. 1C, and by reference number 130, the explainability system 110 may rank the context documents with respect to the query based on the relevance scores. For example, the explainability system 110 may utilize the relevance scores generated by the cross-encoder model to rank and prioritize the context documents, enhancing an ability of the explainability system 110 to identify key information pertinent to the query. By ranking the context documents, the explainability system 110 may ensure that the most relevant context documents are highlighted, which may facilitate a more targeted and efficient analysis of the query by the explainability system 110. In some implementations, the explainability system 110 may rank a context document with a highest relevance score first, may rank a context document with a next highest relevance score second, and so on. In some implementations, the explainability system 110 may discard context documents with relevance scores that fail to satisfy a score threshold. For example, if a score threshold is set at 0.6 and a relevance score of a context document is 0.5, the explainability system 110 may discard the context document.

As shown in FIG. 1D, and by reference number 135, the explainability system 110 may determine semantic similarity scores for sentences in the context documents with respect to the answer. In some implementations, the explainability system 110 may determine the semantic similarity scores for the sentences in the context documents with respect to the answer based on utilizing an asymmetric semantic search with the context documents. For example, the explainability system 110 may employ a semantic search embedding model that embeds the context documents and the answer into a vector space to assess semantic similarities between the context documents and the answer. The semantic search embedding model used by the explainability system 110 may project sentences from the context documents and the answer into the same vector space, allowing similarities between the sentences and the answer to be calculated based on relative positions within the vector space. This may ensure that the explainability system 110 identifies semantically similar sentences, and provides a more accurate assessment of how closely aligned the answer is with supporting context documents. The determination of semantic similarity scores may enable the explainability system to derive insights related to the relevance and correctness of the answer generated by the question-and-answer model.

In some implementations, the explainability system 110 may process the answer to generate answer vector embeddings, and may utilize the asymmetric semantic search with the answer vector embeddings to determine the semantic similarity scores. In some implementations, the explainability system 110 may process the answer and the context documents, with a language model (LM), to generate answer embeddings and context embeddings. The explainability system 110 may utilize the asymmetric semantic search with the answer embeddings and the context embeddings to determine the semantic similarity scores. The language model may include a MiniLM model that is trained on multiple datasets, such as altlex pairs, sentence compression pairs, Quora question pairs (QQP) triplets, probably asked questions (PAQ) pairs, SPECTER triplets, Amazon QA pairs, Simple Wiki pairs, Wiki answers, equivalent sentences, and/or the like.

Additionally, or alternatively, the explainability system 110 may process the context documents and the answer, with a cross-encoder model, to determine additional relevance scores for the context documents with respect to the answer. The explainability system 110 may process the context documents, the answer, and the additional relevance scores, with the semantic search embedding model, to determine the semantic similarity scores for the sentences in the context documents with respect to the answer.

As shown in FIG. 1E, and by reference number 140, the explainability system 110 may re-rank the context documents based on the semantic similarity scores and to generate ranked context documents. For example, the explainability system 110 may utilize the semantic similarity scores, derived from the asymmetric semantic search, to re-rank the context documents and generate the ranked context documents. The re-ranking process may include the explainability system 110 ordering the context documents such that the context documents with the highest semantic similarity scores (e.g., indicating the closest relevance to the answer generated by the question-and-answer model) appear first. In this way, the explainability system 110 may ensure that the most semantically appropriate context documents, which align closely with the provided answer, are highlighted for further processing and review by the explainability system 110. By re-ranking the context documents, the explainability system 110 may enhance the accuracy of the context document relevance, providing a better foundation for subsequent analysis and interpretation. In some implementations, re-ranking the context documents may mitigate the potential for less relevant context documents to impact an overall assessment of the question-and-answer model.

In some implementations, the explainability system 110 may rank a context document with a highest semantic similarity score first, may rank a context document with a next highest semantic similarity score second, and so on. In some implementations, the explainability system 110 may discard context documents with semantic similarity scores that fail to satisfy a score threshold. For example, if a score threshold is set at 0.8 and a semantic similarity score of a context document is 0.7, the explainability system 110 may discard the context document.

As shown in FIG. 1F, and by reference number 145, the explainability system 110 may combine the relevance scores and the semantic similarity scores to generate an explainability score for the answer. For example, the explainability system 110 may aggregate the relevance scores and semantic similarity scores to produce a comprehensive explainability score that assesses the overall relevance and contextual alignment of the answer with respect to both the query and the context documents. The explainability score may enable the explainability system 110 to provide an in-depth evaluation of the answer's validity and the context from which the answer was derived, and provide insights into the decision-making process of the question-and-answer model.

In some implementations, the explainability score generated by the explainability system 110 may provide a quantifiable metric indicating how effectively the context documents support the answer in relation to the query. For example, the explainability score may weigh heavily on context documents with high relevance and strong semantic similarity, ensuring that the most pertinent documents are considered. The explainability score may provide a more streamlined and interpretable output, which users and operators can leverage to better understand and validate outputs of the question-and-answer model.

In some implementations, the explainability system 110 may combine the relevance scores and the semantic similarity scores to generate the explainability score using a weighted aggregation method as follows:

$$E = α \cdot R + β \cdot S ,$$

where E is the explainability score, R represents the relevance scores, S represents the semantic similarity scores, and α and β are weighting coefficients that sum to one (1) and can be empirically determined based on model performance.

As shown in FIG. 1G, and by reference number 150, the explainability system 110 may provide an output that includes the explainability score and a portion of the ranked context documents that support the answer. For example, the explainability system 110 may generate the output that includes the explainability score and the portion of the ranked context documents that support the answer, and may provide the output to the user device 105. The user device 105 may display the output to a user of the user device 105. In some implementations, the portion of the ranked context documents may include segments (e.g., words, sentences, and/or the like) of the most relevant and semantically similar context documents. The output may provide clarity in how the answer was derived by the question-and-answer model and may be presented to users for validation and further insights associated with the question-and-answer model. In some implementations, the users may provide feedback associated with the output, and the explainability system 110 may utilize the feedback to modify the question-and-answer model. In one example, users can analyze the portion of the ranked context documents to trace the logical steps that led to the generated answer by the question-and-answer model.

In some implementations, the explainability system 110 may identify, based on the explainability score, sentences within the ranked context documents that satisfy a threshold level of relevance with respect to the query and the answer, and may provide the sentences in the output. Alternatively, or additionally, the explainability system 110 may generate, based on the explainability score, explainable insights at a sentence level for the ranked context documents, and may provide the explainable insights in the output. In some implementations, the output may further include visual representations of the explainability score, the portion of the ranked context documents that support the answer, and the sentences identified in the ranked context documents. Additionally, or alternatively, the explainability system 110 may store the query, the context documents, the answer, the relevance scores, the semantic similarity scores, and the explainability score in a searchable database. A user of the explainability system 110 may utilize the searchable database to search for a particular query or answer.

As further shown in FIG. 1G, and by reference number 155, the explainability system 110 may utilize the output to update the question-and-answer model. For example, based on the explainability score and the supportive context documents, the explainability system 110 may refine the question-and-answer model by incorporating feedback and adjustments to improve accuracy and relevance in future responses. This iterative learning process may ensure continuous enhancement of performance of the question-and-answer model and its decision-making transparency. In some implementations, the explainability system 110 may update parameters of the question-and-answer model based on the explainability score and the associated context documents, enabling continuous improvements in model accuracy and relevancy. Additionally, or alternatively, the explainability system 110 may iteratively adjust the question-and-answer model to enhance the precision and relevancy of future responses based on the explainability score and the analysis of context documents.

In some implementations, the cross-encoder model and the asymmetric semantic search embedding model may be trained as follows. The cross-encoder model utilized herein may be initially trained on relevant datasets such as the Microsoft® MARCO passage retrieval dataset. The training process may include fine-tuning a pre-trained language model (e.g., BERT or RoBERTa) on pairs of queries and context documents, with the objective of learning to score the relevance of a context document with respect to a given query. The final layer of the cross-encoder model may output a score ranging from zero (0) to one (1), representing the predicted relevance. The model parameters, including learning rate, batch size, and number of training epochs, can be adjusted to optimize performance.

Additionally, the asymmetric semantic search model employs an embedding technique that transforms both the sentences from context documents and the generated answers into a high-dimensional vector space, enabling the calculation of similarity scores. For this purpose, models such as Sentence-BERT (SBERT) can be employed, which involves a Siamese network architecture to produce semantically meaningful sentence embeddings. The parameters for this embedding model may include a maximum sequence length (e.g., of 128 tokens), a batch size (e.g., of 16), and the use of cosine similarity as the distance metric to determine semantic similarity scores.

In some implementations, the explainability system 110 provides compatibility with long sequential context documents. This feature allows the explainability system 110 to handle extensive documents efficiently, thus providing localized analysis and relevance scores even within large datasets. The ability to parse and interpret long documents may be crucial for enterprise applications where information sprawls across multiple documents and sources.

In this way, the explainability system 110 explains the relevance of answers generated by a question-and-answer model. For example, the explainability system 110 may enhance a technical explainability of question-and-answer models. The explainability system 110 may target limitations of the question-and-answer models, and may address the computational efficiency and decision-making process utilized by the question-and-answer models. By integrating relevance and semantic similarity evaluations, the explainability system 110 provides a more detailed analysis of the answer derivation process, pinpointing precisely which sections of context documents are most pertinent to both a query and its answer. The explainability system 110 may validate and refine model outputs against contextually appropriate reference materials. Thus, the explainability system 110 may conserve computing resources, networking resources, and/or other resources that would have otherwise been consumed by failing to ensure that the question-and-answer model generates correct responses, failing to provide sufficient levels of explainability for responses of the question-and-answer model, generating incorrect responses by the question-and-answer model, making incorrect decisions within an enterprise based on the LLM responses, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

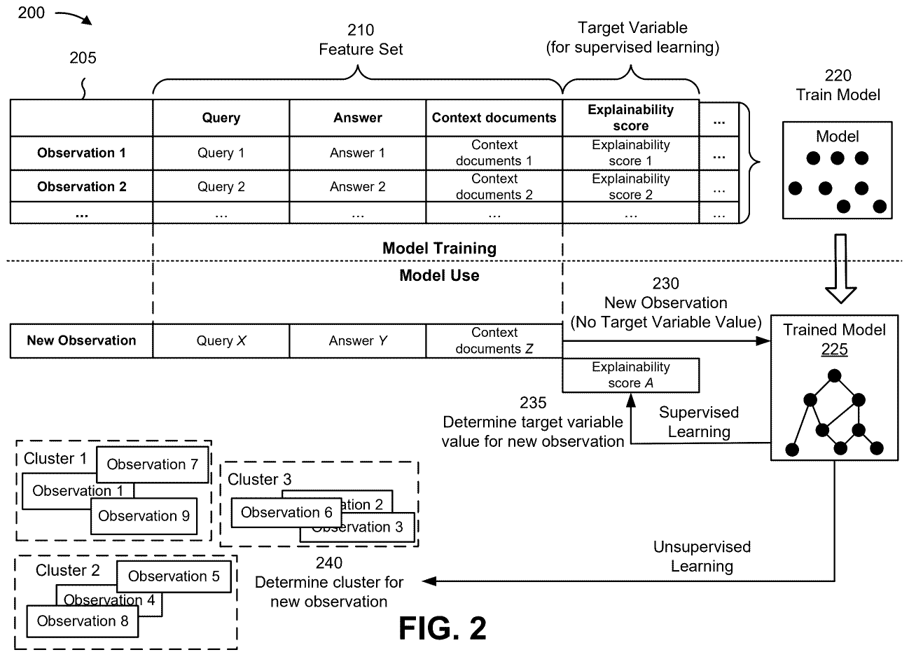

FIG. 2 is a diagram illustrating an example 200 of using a machine learning model. The machine learning usage described herein may be performed using a machine learning system. The machine learning system may include or may be included in a computing device, a server, a cloud computing environment, and/or the like, such as the explainability system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the explainability system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the explainability system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of a query, a second feature of an answer, a third feature of context documents, and so on. As shown, for a first observation, the first feature may have a value of query 1, the second feature may have a value of answer 1, the third feature may have a value of context documents 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be labeled “explainability score” and may include a value of explainability score 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of query X, a second feature of answer Y, a third feature of context documents Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of explainability score A for the target variable of the explainability score for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a query cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., an answer cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to explain the relevance of answers generated by a question-and-answer model. The machine learning system enables recognition and/or identification of tens, hundreds, thousands, or millions of features and/or feature values for tens, hundreds, thousands, or millions of observations, thereby increasing accuracy and consistency and reducing delay associated with explaining the relevance of answers generated by a question-and-answer model relative to requiring computing resources to be allocated for tens, hundreds, or thousands of operators to manually explain the relevance of answers generated by a question-and-answer model.

As indicated above, FIG. 2 is provided as an example. Other examples may differ from what is described in connection with FIG. 2.

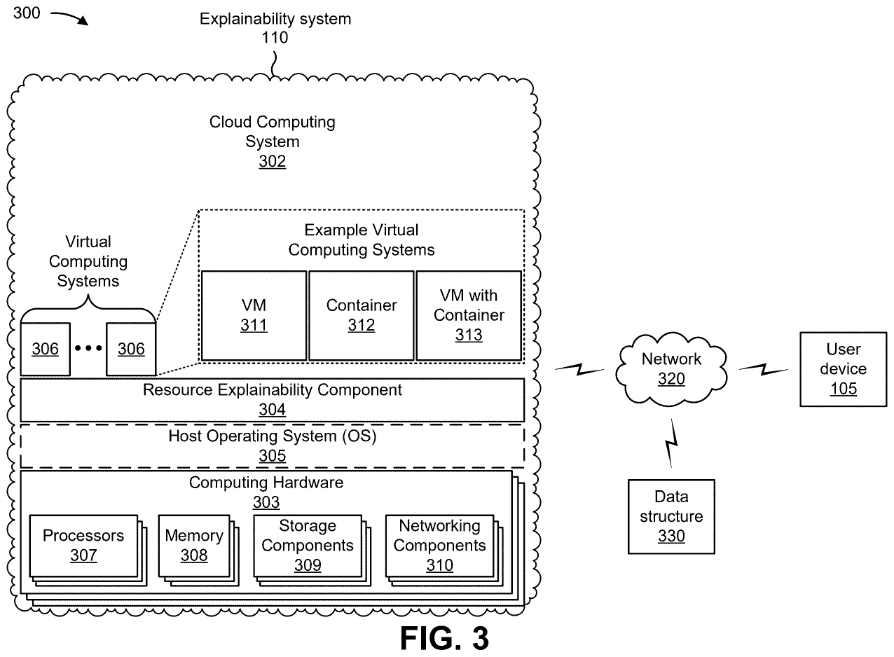

FIG. 3 is a diagram of an example environment 300 in which systems and/or methods described herein may be implemented. As shown in FIG. 3, the environment 300 may include the explainability system 110, which may include one or more elements of and/or may execute within a cloud computing system 302. The cloud computing system 302 may include one or more elements 303-313, as described in more detail below. As further shown in FIG. 3, the environment 300 may include a user device 105, a network 320, and/or a data structure 330. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

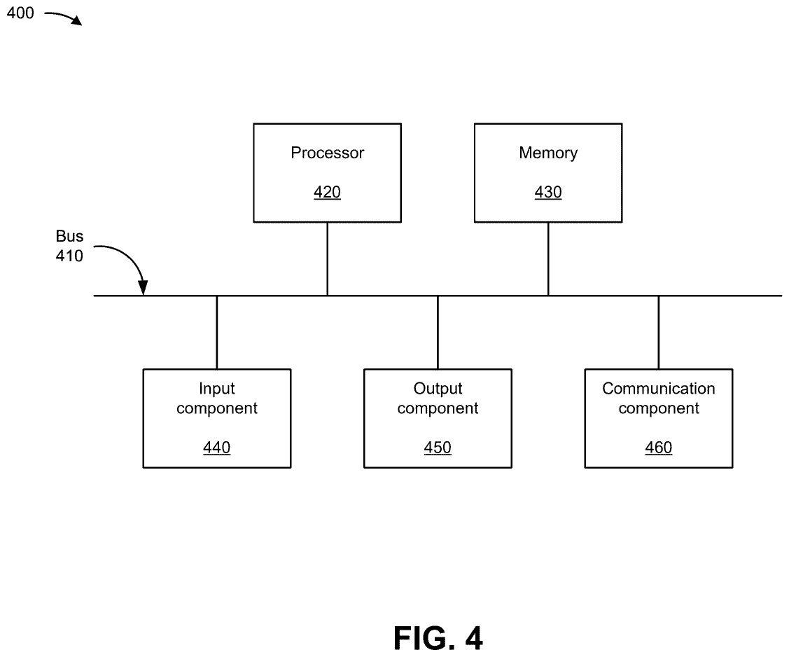

Although the explainability system 110 may include one or more elements 303-313 of the cloud computing system 302, may execute within the cloud computing system 302, and/or may be hosted within the cloud computing system 302, in some implementations, the explainability system 110 may not be cloud-based (e.g., may be implemented outside of a cloud computing system) or may be partially cloud-based. For example, the explainability system 110 may include one or more devices that are not part of the cloud computing system 302, such as a device 400 of FIG. 4, which may include a standalone server or another type of computing device. The explainability system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105, the explainability system 110, and/or the data structure 330. In some implementations, the user device 105, the explainability system 110, and/or the data structure 330 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

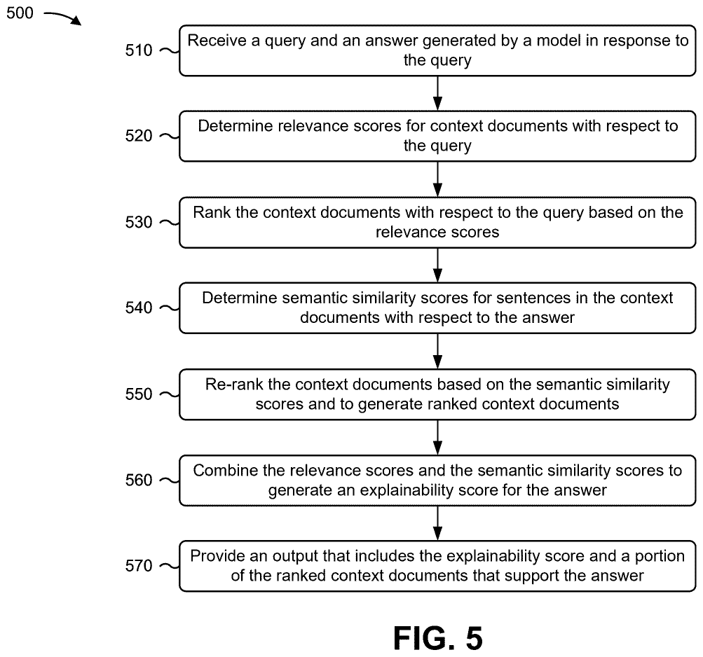

FIG. 5 depicts a flowchart of an example process 500 for explaining the relevance of answers generated by a question-and-answer model. In some implementations, one or more process blocks of FIG. 5 may be performed by a device (e.g., the explainability system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving a query and an answer generated by a model in response to the query (block 510). For example, the device may receive a query and an answer generated by a model in response to the query, as described above. In some implementations, the model is one of a large language model or a retrieval-augment generation model. In some implementations, the model is a question-and-answer model.

As further shown in FIG. 5, process 500 may include determining relevance scores for context documents with respect to the query (block 520). For example, the device may determine relevance scores for the context documents with respect to the query, as described above. In some implementations, determining the relevance scores includes utilizing a cross-encoder model with the context documents to determine the relevance scores for the context documents with respect to the query. In some implementations, each of the relevance scores is calculated as a confidence score ranging from zero to one and indicating a relevance of a respective one of the context documents to the query.

As further shown in FIG. 5, process 500 may include ranking the context documents with respect to the query based on the relevance scores (block 530). For example, the device may rank the context documents with respect to the query based on the relevance scores, as described above.

As further shown in FIG. 5, process 500 may include determining semantic similarity scores for sentences in the context documents with respect to the answer (block 540). For example, the device may determine semantic similarity scores for sentences in the context documents with respect to the answer, as described above. In some implementations, determining the semantic similarity scores for the sentences in the context documents with respect to the answer includes utilizing an asymmetric semantic search with the context documents to determine the semantic similarity scores for the sentences in the context documents with respect to the answer.

As further shown in FIG. 5, process 500 may include re-ranking the context documents based on the semantic similarity scores and to generate ranked context documents (block 550). For example, the device may re-rank the context documents based on the semantic similarity scores and to generate ranked context documents, as described above.

As further shown in FIG. 5, process 500 may include combining the relevance scores and the semantic similarity scores to generate an explainability score for the answer (block 560). For example, the device may combine the relevance scores and the semantic similarity scores to generate an explainability score for the answer, as described above.

As further shown in FIG. 5, process 500 may include providing an output that includes the explainability score and a portion of the ranked context documents that support the answer (block 570). For example, the device may provide an output that includes the explainability score and a portion of the ranked context documents that support the answer, as described above. In some implementations, the output further includes visual representations of the explainability score and the portion of the ranked context documents.

In some implementations, process 500 includes processing the query and the context documents to generate context vector embeddings, wherein utilizing the cross-encoder model with the context documents to determine the relevance scores includes utilizing the cross-encoder model with the context vector embeddings to determine the relevance scores. In some implementations, process 500 includes processing the answer to generate answer vector embeddings, wherein utilizing the asymmetric semantic search with the context documents to determine the semantic similarity scores includes utilizing the asymmetric semantic search with the answer vector embeddings to determine the semantic similarity scores.

In some implementations, process 500 includes identifying, based on the explainability score, sentences within the ranked context documents that satisfy a threshold level of relevance with respect to the query and the answer. In some implementations, process 500 includes generating, based on the explainability score, explainable insights at a sentence level for the ranked context documents, and providing the explainable insights for display. In some implementations, process 500 includes storing the query, the context documents, the answer, the relevance scores, the semantic similarity scores, and the explainability score in a searchable database. In some implementations, process 500 includes utilizing the output to update the model.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code—it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method comprising:
receiving, by a device, a query and an answer generated by a model in response to the query;
determining, by the device, relevance scores for context documents with respect to the query;
ranking, by the device, the context documents with respect to the query based on the relevance scores;
determining, by the device, semantic similarity scores for sentences in the context documents with respect to the answer;
re-ranking, by the device, the context documents based on the semantic similarity scores and to generate ranked context documents;
combining, by the device, the relevance scores and the semantic similarity scores to generate an explainability score for the answer; and
providing, by the device, an output that includes the explainability score and a portion of the ranked context documents that support the answer.

2. The method of claim 1, further comprising:
processing the query and the context documents to generate context vector embeddings,
wherein utilizing the cross-encoder model with the context documents to determine the relevance scores comprises:
utilizing the cross-encoder model with the context vector embeddings to determine the relevance scores.

3. The method of claim 1, further comprising:
processing the answer to generate answer vector embeddings,
wherein utilizing the asymmetric semantic search with the context documents to determine the semantic similarity scores comprises:
utilizing the asymmetric semantic search with the answer vector embeddings to determine the semantic similarity scores.

4. The method of claim 1, wherein determining the relevance scores comprises:
utilizing a cross-encoder model with the context documents to determine the relevance scores for the context documents with respect to the query.

5. The method of claim 1, wherein determining the semantic similarity scores for the sentences in the context documents with respect to the answer comprises:
utilizing an asymmetric semantic search with the context documents to determine the semantic similarity scores for the sentences in the context documents with respect to the answer.

6. The method of claim 1, wherein each of the relevance scores is calculated as a confidence score ranging from zero to one and indicating a relevance of a respective one of the context documents to the query.

7. The method of claim 1, further comprising:
identifying, based on the explainability score, sentences within the ranked context documents that satisfy a threshold level of relevance with respect to the query and the answer.

8. A device, comprising:
one or more processors configured to:
receive a query and an answer generated by a model in response to the query;
utilize a cross-encoder model with context documents to determine relevance scores for the context documents with respect to the query;
rank the context documents with respect to the query based on the relevance scores;
utilize an asymmetric semantic search with the context documents to determine semantic similarity scores for sentences in the context documents with respect to the answer;
re-rank the context documents based on the semantic similarity scores and to generate ranked context documents;
combine the relevance scores and the semantic similarity scores to generate an explainability score for the answer; and
identify, based on the explainability score, sentences within the ranked context documents that satisfy a threshold level of relevance with respect to the query and the answer; and
provide an output that includes the explainability score and the sentences identified in the ranked context documents.

9. The device of claim 8, wherein the one or more processors are further configured to:
generate, based on the explainability score, explainable insights at a sentence level for the ranked context documents; and
provide the explainable insights for display.

10. The device of claim 8, wherein the model is one of a large language model or a retrieval-augment generation model.

11. The device of claim 8, wherein the one or more processors are further configured to:
store the query, the context documents, the answer, the relevance scores, the semantic similarity scores, and the explainability score in a searchable database.

12. The device of claim 8, wherein the output further includes visual representations of the explainability score and the sentences identified in the ranked context documents.

13. The device of claim 8, wherein the model is a question-and-answer model.

14. The device of claim 8, wherein the one or more processors are further configured to:
utilize the output to update the model.

15. A non-transitory computer-readable medium storing a set of instructions, the set of instructions comprising:
one or more instructions that, when executed by one or more processors of a device, cause the device to:
receive a query and an answer generated by a model in response to the query,
wherein the model is a question-and-answer model;
utilize a cross-encoder model with context documents to determine relevance scores for the context documents with respect to the query;
rank the context documents with respect to the query based on the relevance scores;
utilize an asymmetric semantic search with the context documents to determine semantic similarity scores for sentences in the context documents with respect to the answer;
re-rank the context documents based on the semantic similarity scores and to generate ranked context documents;
combine the relevance scores and the semantic similarity scores to generate an explainability score for the answer; and
provide an output that includes the explainability score and a portion of the ranked context documents that support the answer.

16. The non-transitory computer-readable medium of claim 15, wherein the one or more instructions further cause the device to:
process the query and the context documents to generate context vector embeddings,
wherein the one or more instructions, that cause the device to utilize the cross-encoder model with the context documents to determine the relevance scores, cause the device to:
utilize the cross-encoder model with the context vector embeddings to determine the relevance scores.

17. The non-transitory computer-readable medium of claim 15, wherein the one or more instructions further cause the device to:
process the answer to generate answer vector embeddings,
wherein the one or more instructions, that cause the device to utilize the asymmetric semantic search with the context documents to determine the semantic similarity scores, cause the device to:
utilize the asymmetric semantic search with the answer vector embeddings to determine the semantic similarity scores.

18. The non-transitory computer-readable medium of claim 15, wherein the one or more instructions further cause the device to:
identify, based on the explainability score, sentences within the ranked context documents that satisfy a threshold level of relevance with respect to the query and the answer.

19. The non-transitory computer-readable medium of claim 15, wherein the one or more instructions further cause the device to:
generate, based on the explainability score, explainable insights at a sentence level for the ranked context documents; and
provide the explainable insights for display.

20. The non-transitory computer-readable medium of claim 15, wherein the one or more instructions further cause the device to:
utilize the output to update the model.
